(19) United States
(12) Patent Application Publication
(10) Pub. No.: US 2020/0395770 A1
(43) Pub. Date: Dec. 17, 2020

(54) CHARGER WITH DETACHABLE REPLACING ADAPTOR

(71) Applicant: Powergene Technology Co., Ltd., Taiwan Branch, New Taipei City (TW)

(72) Inventor: Hui-Te HSU, New Taipei City (TW)

(21) Appl. No.: 16/440,441

(22) Filed: Jun. 13, 2019

(51) Int. Cl. H02J 7/00; H01R 13/66

(52) U.S. Cl. CPC H02J 7/0045; H02J 7/0052; H01R 13/6675

(57) ABSTRACT

A charger with detachable replacing adaptor includes a charger main body, an adaptor and a buckle releasing assembly; the charger main body has a housing in which a guiding structure and a buckle part are disposed, and the guiding structure has electric conducive terminals; the adaptor has an insulation base and electric conducive units, the insulation base is combined corresponding to the guiding structure, the electric conductive units are electrically connected to the electric conductive terminals, and the insulation base has an elastic latch hook; the buckle releasing assembly is disposed on the insulation base and has a moveable unit, the moveable unit has a push rod used for driving the elastic latch hook to be released corresponding to the buckle part. Accordingly, the adaptor can be rapidly detached from the charger main body.

### BACKGROUND OF THE INVENTION

### Field of the Invention

The present invention relates to a charger, especially to a charger with detachable replacing adaptor.

### Description of Related Art

People would often carry various types of electronic products, for example a mobile phone, a notebook computer, a tablet computer and a digital camera, to maintain the daily contacts while being away from home for different reasons, for example a business trip, a holiday or a visit to acquaintance; however, the stored power in the electronic products may run out after being used for a certain time, thus a charger for charging the various types of electronic products is required to be carried around.

Because power plugs are designed in different shapes in various countries, the consumer has to buy adaptors with various specifications while visiting another country for matching with the power plugs with different specifications. To solve the above-mentioned problem, the skilled people in the art have developed an assembled adaptor, a main body of the adaptor has a main plug, and provided with a plurality of replaceable plugs as accessories which can be connected to the main plug, each of the replaceable plugs has two connection interfaces, one of the connection interfaces is used for being inserted in the main plug, and the other is used for being inserted in a power socket with a certain specification, so that the assembled adaptor can be inserted in the power sockets with various specifications.

However, an insertion means is adopted for connecting and fastening the conventional adaptor and the charger, so that situations of the adaptor and the charger being difficult to be separated due to an overly-tight combination or the adaptor and the charger being easily to be released due to an overly-loose combination may happen.

Accordingly, the applicant of the present invention has devoted himself for improving the mentioned disadvantages.

### SUMMARY OF THE INVENTION

The present invention is to provide a charger with detachable replacing adaptor, which has an advantage of enabling an adaptor to be rapidly detached from a charger main body through pressing a buckle releasing assembly.

Accordingly, the present invention provides a charger with detachable replacing adaptor, which includes a charger main body, an adaptor and a buckle releasing assembly; the charger main body has a housing, one side of the housing is disposed with a guiding structure and a buckle part, and the guiding structure has a plurality of electric conducive terminals; the adaptor has an insulation base and a plurality of electric conducive units fastened on the insulation base, the insulation base is combined corresponding to the guiding structure, each of the electric conductive units is electrically connected to each of the electric conductive terminals, and the insulation base has an elastic latch hook; the buckle releasing assembly is disposed on the insulation base and has a moveable unit, the moveable unit has a push rod, the push rod is used for driving the elastic latch hook to be released corresponding to the buckle part.

In comparison with related art, the present invention has an advantageous feature as follows. The moveable unit is provided with an automatic recovering effect through a spring being elastically clamped between a holding block and a rectangular frame.

### BRIEF DESCRIPTION OF DRAWING

FIG. 1 is a perspective exploded view showing a charger with detachable replacing adaptor according to the present invention;

FIG. 2 is a perspective exploded view showing the adaptor according to the present invention;

FIG. 3 is a perspective view showing the assembly of the adaptor according to the present invention;

FIG. 4 is a cross sectional view showing the adaptor yet being combined with the charger main body according to the present invention;

FIG. 5 is another cross sectional view showing the adaptor yet being combined with the charger main body according to the present invention;

FIG. 6 is a schematic view showing the assembly of the adaptor being combined with the charger main body according to the present invention;

FIG. 7 is a cross sectional view showing the assembly of the adaptor being combined with the charger main body according to the present invention;

FIG. 8 is another cross sectional view showing the assembly of the adaptor being combined with the charger main body according to the present invention; and

FIG. 9 is a cross sectional view showing the buckle releasing assembly being operated for enabling the adaptor to be released from the charger main body according to the present invention.

### DETAILED DESCRIPTION OF THE INVENTION

A preferred embodiment of the present invention will be described with reference to the drawings.

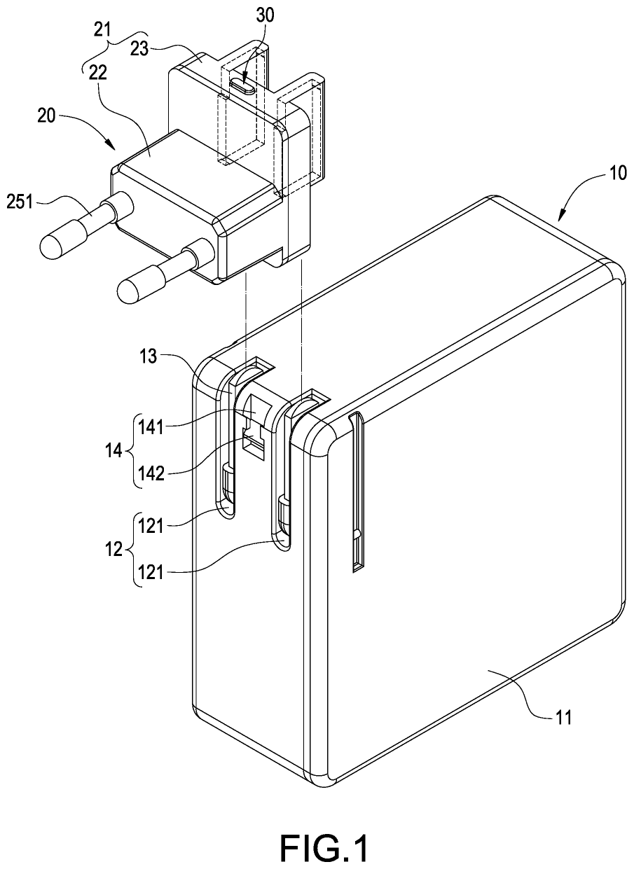

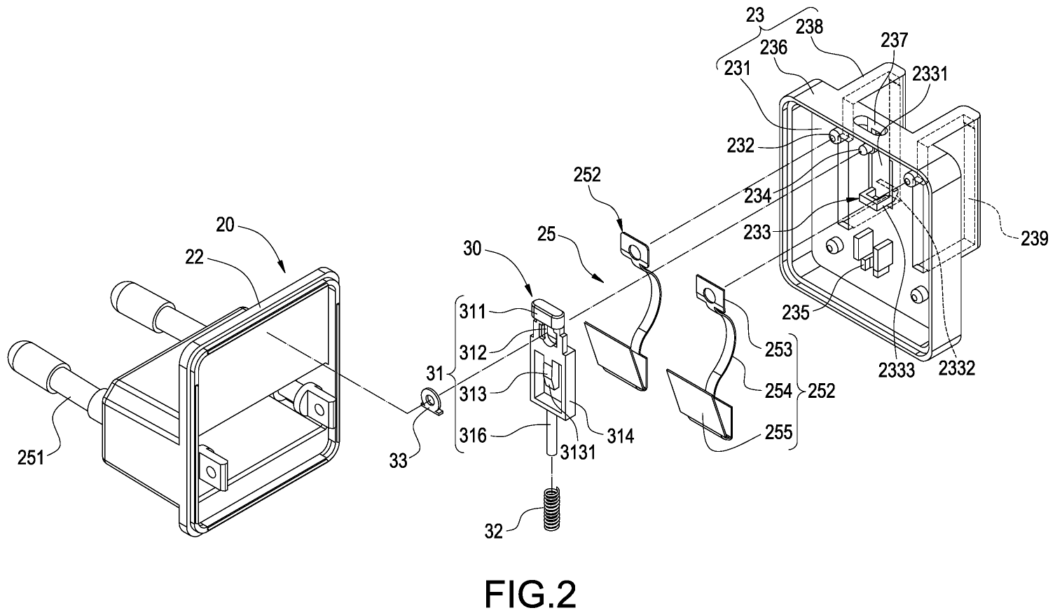

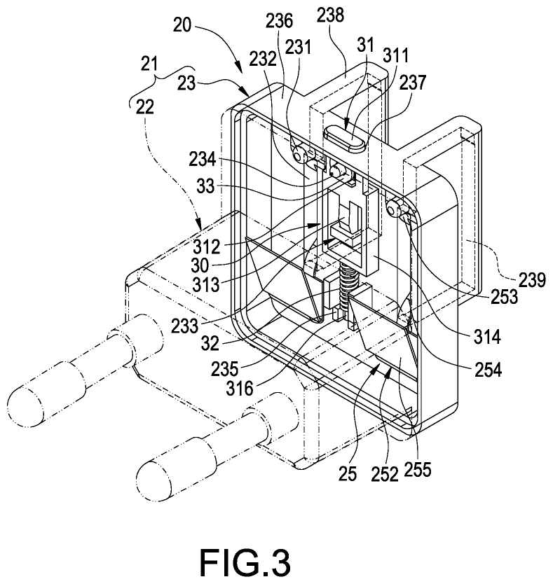

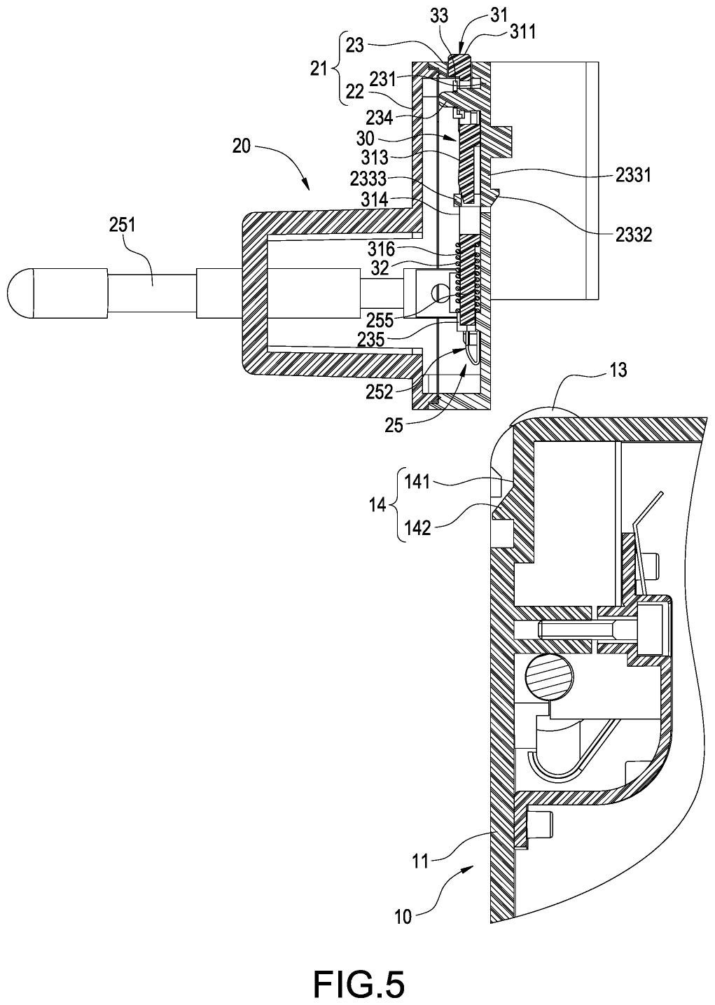

Please refer from FIG. 1 to FIG. 5, a charger with detachable replacing adaptor including a changer main body 10, an adaptor 20 and a buckle releasing assembly 30 is disclosed by the present invention.

The charger main body 10 has a housing 11 and other internal electronic or electromechanical components disposed in the housing 11, for example a mobile power bank; according to this embodiment, the housing 11 is substantially formed as a rectangular member, but what shall be addressed is that the scope of the present invention is not limited to the above-mentioned arrangement. A guiding structure 12 is disposed at one side of the housing 11; according to this embodiment, the guiding structure 12 is two slot runners 121 arranged to be parallel to each other, an electric conductive terminal 13 is disposed in each of the slot runners 121, each of the electric conductive terminals 13 is electrically connected to the internal electronic or electromechanical components, a buckle part 14 is disposed in the housing 11 and arranged between the slot runners 121; according to this embodiment, the buckle part 14 mainly has a recess 141 and a latch block 142 formed in the recess 141.

The adaptor 20 mainly has an insulation base 21 and a plurality of electric conductive units 25; according to this embodiment, the insulation base 21 mainly has a front cover 22 and a rear cover 23, the front cover 22 is correspondingly engaged and assembled with the rear cover 23; according to this embodiment, the electric conductive unit 25 mainly has an insertion pin 251 and a metal elastic sheet 252, the insertion pin 251 is fastened in the front cover 22, and one end of the insertion pin 251 is exposed at a front exterior of the front cover 22.

The rear cover 23 mainly has a bottom plate 231, an annular frame 236 extended from one side of the bottom plate 231 and a plurality of ribs 238 extended from another side of the bottom plate 231, a plurality of positioning columns 232 are extended from an inner surface of the bottom plate 231, and an elastic latch hook 233 is disposed at a central location of the bottom plate 231. The elastic latch hook 233 mainly has an elastic arm 2331, a hook part 2332 extended from an outer surface of the elastic arm 2331 and a frame part 2333 extended from an inner surface of the elastic arm 2331, and three sides of the elastic arm 2331 are separated from the bottom plate 231. A fastening column 234 is disposed above the elastic latch hook 233 and extended from the bottom plate 231, and a holding block 235 is disposed below the elastic latch hook 233. Moreover, a penetrated hole 237 is formed at an upper central location of the annular frame 236. An elastic sheet chamber 239 is formed inside each of the ribs 238, and the elastic sheet chambers 239 are allowed to pass bottom surfaces of the ribs 238 and the bottom plate 232. The metal elastic sheet 252 has a fastening segment 253, an arc-shaped segment 254 extended from one distal end of the fastening segment 253 and an abutting segment 255 extended from the arc-shaped segment 254. The fastening segment 253 is fastened on the bottom plate 231 via the positioning column 232, the arc-shaped segment 254 is accommodated in the elastic sheet chamber 239, and the abutting segment 255 is elastically abutted against another end of the insertion pin 251.

The buckle releasing assembly 30 is disposed on the insulation base 21 and mainly has a moveable unit 31, a spring 32 and a fastening sheet 33. The moveable unit 31 mainly has a pressing cap 311, a connection frame 312 downwardly extended from the pressing cap 311, a push rod 313 and a rectangular frame 314 downwardly extended from the connection frame 312 and a rod member 316 downwardly extended from the rectangular frame 314. A push inclined surface 3131 is formed at a bottom portion of the push rod 313, a top side of the push rod 313 is mutually connected with the rectangular frame 314, and other three sides thereof are separated from the rectangular frame 314.

Details are provided as follows. The push rod 313 is received in the frame part 2333, the pressing cap 311 is protruded out from the penetrated hole 237 so as to be exposed outside the annular frame 236, the rod member 316 is correspondingly disposed with respect to the holding block 235, the spring 32 is sleeved at an outer periphery of the rod member 316 and elastically clamped between the holding block 235 and the rectangular frame 314, so that the moveable unit 31 is able to be provided with an automatic recovering effect. The fastening sheet 33 is fastened at one distal part of the fastening column 324 after the moveable unit 31 is sleeved on the fastening column 234 via the connection frame 312, thereby preventing the moveable unit 31 from being released.

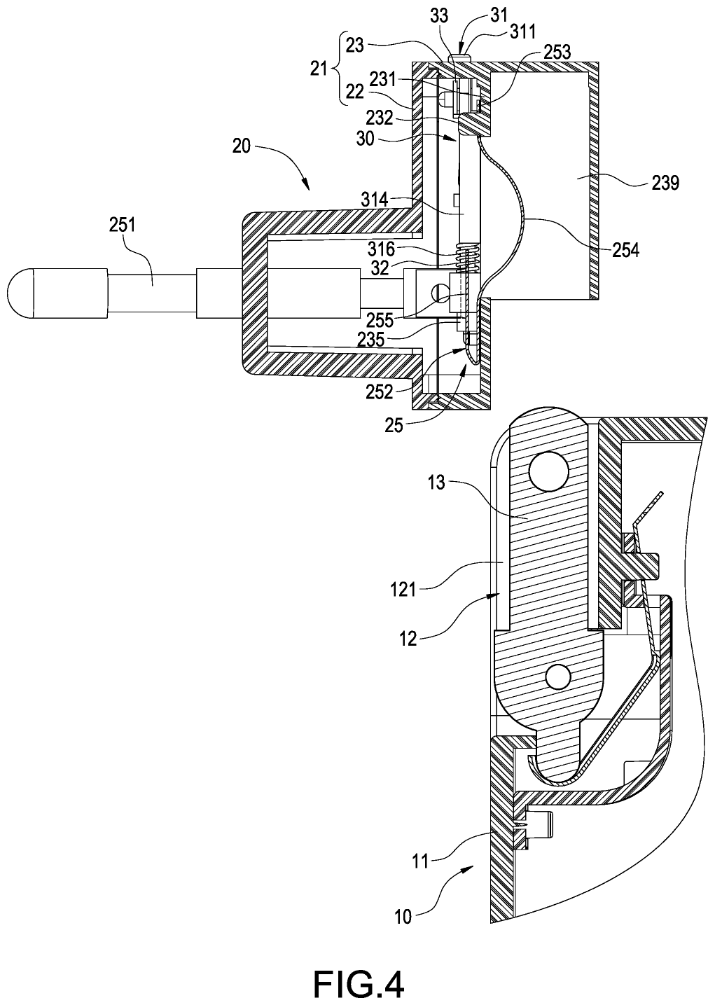

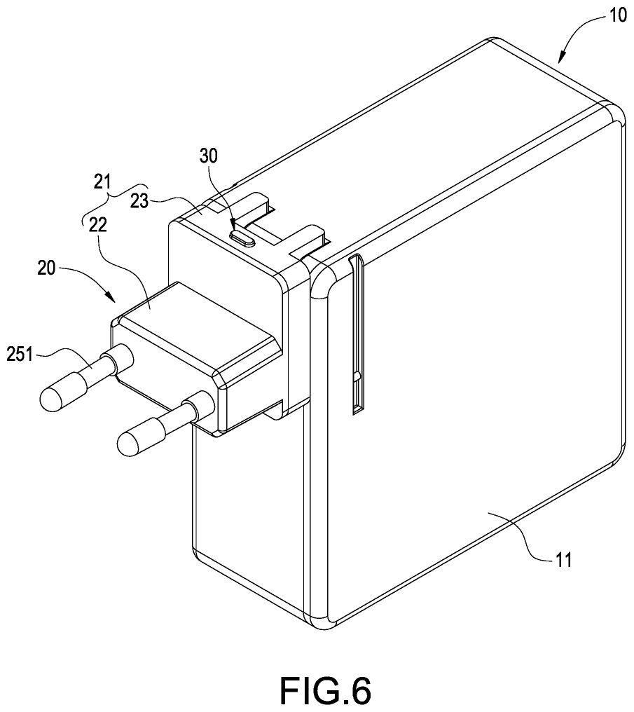

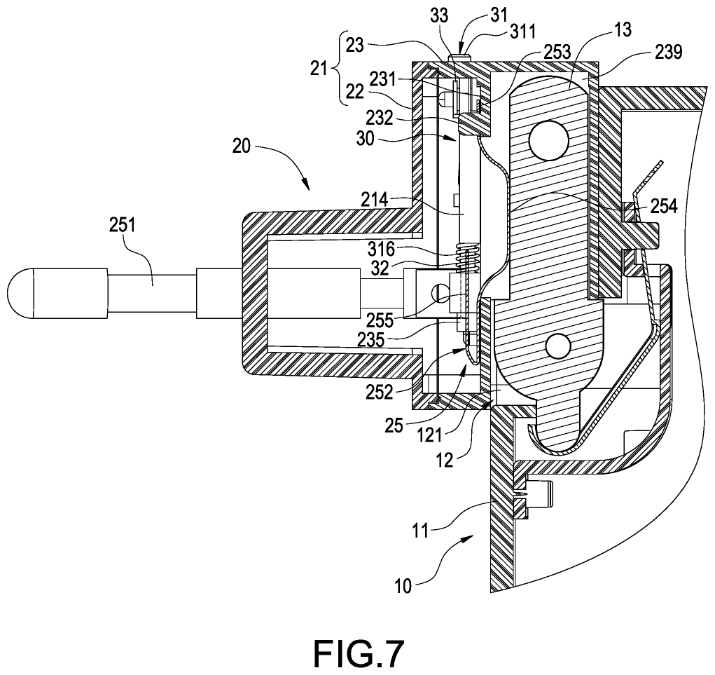

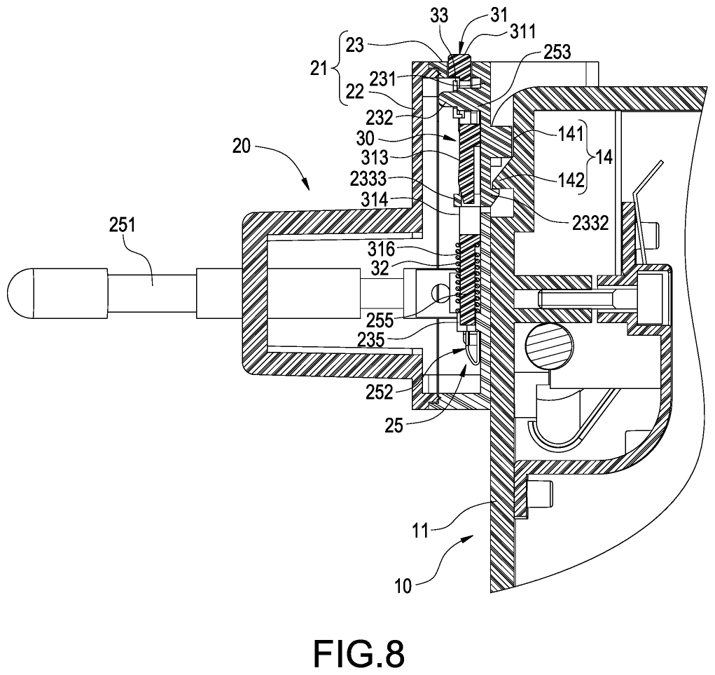

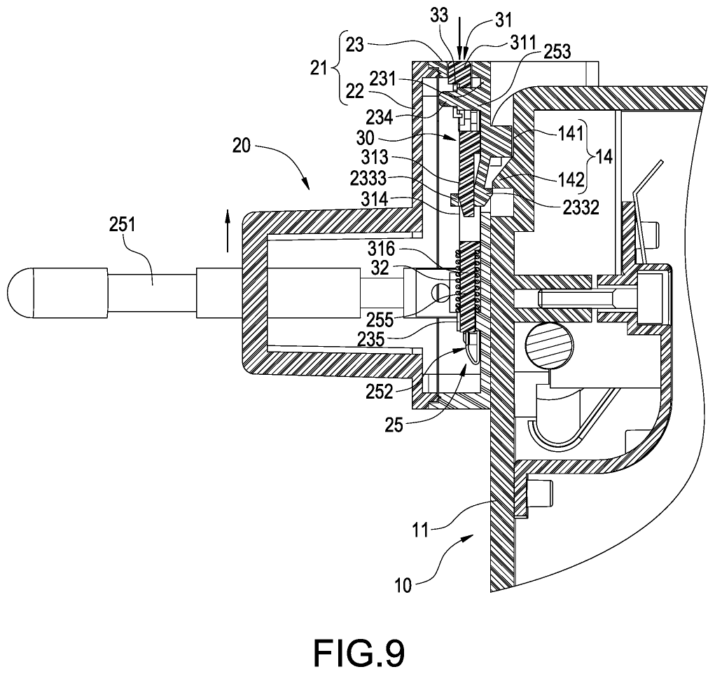

Please refer from FIG. 4 to FIG. 7, when being assembled, each of the ribs 238 of the adaptor 20 is aimed at each of the slot runners 121 of the charger main body 10 so as to be mounted therein, and the elastic latch hook 233 is enabled to enter from the recess 141, at this moment each of the electric conductive terminals 31 is inserted from the elastic sheet chamber 239 so as to be electrically connected to each of the arc-shaped segments 254, so that the elastic latch hook 233 can be mutually latched with latch block 142. As such, the present invention can be used for charging electronic products with various specifications. Please refer to FIG. 8 and FIG. 9, when a user wants to change to another adaptor with another specification, the adaptor 20 is firstly detached, then the pressing cap 311 is pressed for being downwardly displaced, the elastic latch hook 233 is driven through the push rod 313 being inserted in the frame part 2333, and the hook part 2332 is able to be released from the latch block 142 through the push inclined surface 3131 being served to push the elastic arm 2331 to be elastically deformed towards a rear direction. As such, the adaptor 20 can be easily and rapidly detached from the charger main body 10.

Based on what has been mentioned above, the charger with detachable replacing adaptor provided by the present invention is novel and more practical in use comparing to prior arts.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A charger with detachable replacing adaptor, including:
a charger main body, having a housing, wherein one side of the housing is disposed with a guiding structure and a buckle part, and the guiding structure has a plurality of electric conducive terminals;
an adaptor, having an insulation base and a plurality of electric conducive units fastened on the insulation base, wherein the insulation base is combined corresponding to the guiding structure, each of the electric conductive units is electrically connected to each of the electric conductive terminals, and the insulation base has an elastic latch hook;
a buckle releasing assembly, disposed on the insulation base and having a moveable unit, wherein the moveable unit has a push rod, and the push rod is used for driving the elastic latch hook to be released corresponding to the buckle part.

2. The charger with detachable replacing adaptor according to claim 1, wherein the insulation base has a bottom plate and an annular frame, the elastic latch hook has an elastic arm and a frame part extended from the elastic arm, the annular frame is formed with a penetrated hole, the moveable unit further has a pressing cap, the push rod is formed with a push inclined surface, the push rod is able to drive the frame part via the push inclined surface, and the pressing cap is protruded out from the penetrated hole so as to be exposed outside the annular frame.

3. The charger with detachable replacing adaptor according to claim 2, wherein the buckle part has a latch block, the elastic latch hook further has a hook part extended from the elastic arm, and the hook part is latched corresponding to the latch block.

4. The charger with detachable replacing adaptor according to claim 3, wherein the buckle releasing assembly further has a spring, the moveable unit further has a connection frame extended from the pressing cap, a rectangular frame extended from the connection frame and a rod member extended from the rectangular frame, a holding block is disposed below the elastic latch hook, the rod member is correspondingly disposed with respect to the holding block, and the spring is sleeved on the rod member and elastically clamped between the holding block and the rectangular frame.

5. The charger with detachable replacing adaptor according to claim 1, wherein the buckle part has a recess formed in the housing and a latch block formed in the recess, and the latch block and the elastic latch hook are able to be mutually latched or released.

6. The charger with detachable replacing adaptor according to claim 1, wherein the guiding structure is formed as a plurality of slot runners which are arranged to be parallel to each other, and the electric conductive terminals are disposed in the slot runners.

7. The charger with detachable replacing adaptor according to claim 1, wherein the insulation base has a front cover and a rear cover capable of being engaged corresponding to the front cover, the electric conductive unit has an insertion pin and a metal elastic sheet, the insertion pin is fastened in front cover, and the metal elastic sheet is fastened in the rear cover and electrically connected to the insertion pin.

8. The charger with detachable replacing adaptor according to claim 7, wherein the rear cover has a bottom plate and a plurality of ribs extended from the bottom plate, an elastic sheet chamber is formed in each of the ribs, and the elastic sheet chamber is allowed to pass a bottom surface of the rib and the bottom plate.

9. The charger with detachable replacing adaptor according to claim 8, wherein the metal elastic sheet has a fastening segment, an arc-shaped segment extended from the fastening segment and an abutting segment extended from the arc-shaped segment, the fastening segment is fastened on the bottom plate, the arc-shaped segment is accommodated in the elastic sheet chamber, and the abutting segment is elastically abutted against the insertion pin.

10. The charger with detachable replacing adaptor according to claim 8, wherein the guiding structure is formed as a plurality of slot runners which are arranged to be parallel to each other, and each of the ribs is mounted corresponding to each of the slot runners.
